(19) United States
(12) Patent Application Publication
(10) Pub. No.: US 2003/0123341 A1
(43) Pub. Date: Jul. 3, 2003

(54) Flexible architecture for rail mounted multiple robots in a storage library

(76) Inventors: Timothy C. Ostwald, Louisville, CO (US); Daniel James Plutt, Superior, CO (US)

Correspondence Address: STORAGE TECHNOLOGY CORPORATION, One StorageTek Drive, Louisville, CO, 80028-4309, US

(21) Appl. No.: 10/034,134

(22) Filed: Dec. 28, 2001

(51) Int. Cl. G11B 7/085; G11B 21/08; G11B 15/68

(52) U.S. Cl. 369/30.43; 360/92; 369/30.49; 369/30.45

(57) ABSTRACT

A storage library with a stand-alone guide rail system is provided. The library comprises at least one array of storage cells and a guide rail running along the storage cells. A picker robot is coupled to the guide rail, wherein the robot moves along the guide rail and can manipulate objects within the storage cells. The library also comprises a central power source and controller that controls the movement of the robot. The robot receives power and control only from the central power source and controller directly through the guide rail, without any external input from other components in the library. In one embodiment, multiple library enclosures are connected with guide rails, wherein the guide rails form a single, integrated power and communication connection between the robot and the central power source and controller, independent and exclusive of the separate enclosures.

### BACKGROUND OF THE INVENTION

1. Field of the Invention

The present invention relates generally to robotic media storage library systems, and more specifically to a redundant system that includes a plurality of independent robots in the form of robotic pods.

2. Background of the Invention

The current enterprise class library system contains multiple independent robots for concurrently manipulating multiple media cartridges. The library system comprises an array of media storage cells and media cartridge players. A system of rails is used to guide robotic pods through al of the locations on the array.

Data storage library architectures are shaped to take advantage of robotic efficiency. The robot is often constrained by a pivot point or containment rail, which limits the size and performance of the library and eventually establishes cost/performance levels for a design. Problems are presented as library systems become larger, and computer room configurations sometimes require a site planner to design an installation. Some large systems use pass through mechanisms to pass cartridges between individual silos. The pass through system is implemented because the boundaries of the library enclosure constrain the maximum size of the system. However, pass through mechanisms may be undesirable for cost and efficiency reasons.

Library enclosure boundaries also create control and communication problems. Connecting together large systems of libraries involves the use of many cables for communication between library control modules, as well as for communication and power between robots and controllers.

Library enclosures typically consist of barrier walls that are designed to enclose the library components (i.e. robots, storage cells, media drives, etc.) and provide data security, as well as provide physical isolation of electrical components and containment of electromagnetic interference (EMI). However, these boundaries inhibit design flexibility and limit the growth of library systems.

Therefore, it would be desirable to have a method for scaling large library systems in a cost effective and efficient manner, while providing a logical way to implement physical media storage walls and connect signal and power supplies to robots and controllers.

### SUMMARY OF THE INVENTION

The present invention provides a storage library with a stand-alone guide rail system. The library comprises at least one array of storage cells and a guide rail running along the storage cells. A picker robot is coupled to the guide rail, wherein the robot moves along the guide rail and can manipulate objects within the storage cells. The library also comprises a central power source and controller that controls the movement of the robot. The robot receives power and control only from the central power source and controller directly through the guide rail, without any external input from other components in the library. In one embodiment, multiple library enclosures are connected with guide rails, wherein the guide rails form a single, integrated power and communication connection between the robot and the central power source and controller, independent and exclusive of the separate enclosures.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a perspective pictorial diagram illustrating the architecture of a single library storage module;

FIG. 2 depicts a pictorial diagram illustrating a robotic picker mechanism in accordance with the present invention;

FIG. 3A depicts a pictorial diagram illustrating a robotic picker mechanism holding a media cartridge in an extended position, in accordance with the present invention;

FIG. 3B depicts a pictorial diagram illustrating a robotic picker mechanism holding a media cartridge in a retracted position, in accordance with the present invention;

FIG. 4 depicts a schematic diagram illustrating a stand-alone guide rail system in accordance with the present invention;

FIG. 5 depicts a top view, pictorial diagram illustrating a library, with inside and outside curving connections, in accordance with the present invention; and

FIG. 6 depicts a schematic diagram illustrating a stand-alone guide rail system without an enclosure in accordance with the present invention.

### DETAILED DESCRIPTION OF THE PREFERRED EMBODIMENT

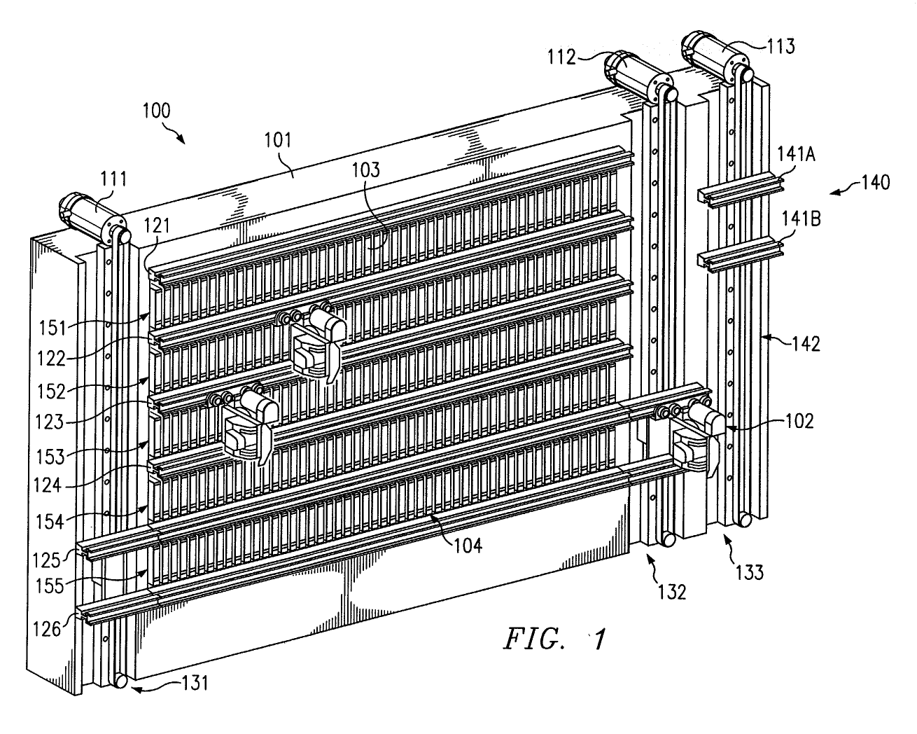

The architecture of an automated library system 100 is illustrated in FIG. 1 and contains the multiple independent robots 102 to enable the library system 100 to concurrently manipulate multiple media cartridges 105. The library system 100 comprises a two-dimensional array of media cartridge storage cells 103 and media cartridge players 104 that are mounted in a frame 101. A system of rails 121-126 is used to guide robotic pods 102 through all of the locations in the array, which eliminates the need for any steering or guide mechanisms on board the robotic pods 102, resulting in a reduction in the mass of the robotic pods 102. The rail system 121-126 also constrains the movement of the robotic pods 102 into horizontal and vertical movements, thereby simplifying the control algorithms for collision avoidance that are required by a typical random moveable object handling system based on horizontal, vertical and diagonal degrees of freedom. The robotic pods 102 contain a moveable carriage that is capable of transporting robotic components, such as media cartridge pickers, bar code reading devices, and other task oriented sub-modules, on the storage library rail system.

As shown in FIG. 1, the frame 101 is designed to receive a plurality of rows 151-154 of media cartridge storage cells 103, each of which is designed to house a single media cartridge 105. The media cartridge players 104 are shown in an arbitrary location in a horizontal row 155 at the bottom of the frame 101, although the library system 100 can incorporate media cartridge players 104 at any location in the frame 101 to optimize performance. The robotic pods 102 are attached to the frame 101 via horizontal guide rails 121-126, which serve to frame the media cartridge storage cells 103 and media cartridge players 104 on the top and bottom sides thereof. FIG. 1 shows an array of media storage cells 103 fully populated with media cartridges 105 of any arbitrary type. The robotic pod guide rails 121-126 provide support of the robotic pods 102 in the vertical direction to oppose the force of gravity, and they also provide a meshing surface of suitable design to impart traction in the horizontal direction for motive transport of the robotic pods 102. The robotic pods 102 each incorporate a drive means for propulsion in the horizontal direction along the guide rails 121.

FIG. 1 also shows a plurality of vertical elevator assemblies 131-133 that enable the transfer of the robotic pods 102 in the vertical direction. Multiple vertical elevator assemblies 131-133 are shown in FIG. 1 to exemplify the extensibility and redundancy of the invention. Each of the vertical elevator assemblies 131-133 comprise a set of vertical rails 142 that extend substantially from the top of the frame 101 to the bottom of the frame 101. The vertical rails 142 support a plurality of elevator stations 140, each of which contain short horizontal rail segments 141A, 141B that are identical in cross section to the main horizontal guide rails 121-126. The elevator stations 140 are held in suspension by a drive belt 143 which is made to wrap around a drive pulley attached to a vertical drive motor 113 that is located at the top of each elevator assembly 133. When a vertical displacement is required of any robotic pod 102, the vertical elevator 140 is scheduled to move in alignment to the appropriate level of rows 151-155 to allow transfer of the robotic pod 102 onto the elevator rail section 141A, 141 B from the pair of horizontal rails 121-126 that are juxtaposed and abutting to the elevator rails 141A, 141B. Once the robotic pod 102 is located on the elevator station 140, the drive motor 113 is activated to transport the robotic pod 102 to a selected one of rows 151-155 and thence moves on to the pair of horizontal rails 121-126 that correspond to the selected row. Elevator assemblies 131-133 can carry more than one robotic pod 102 at a time by adding elevator platforms 140 to the elevator assemblies 131-133 or by extending the elevator platform length to accommodate multiple robotic pods 102 on a single elevator station 140.

Library storage modules such as library system 100 may be placed in enclosures, either singly or in combination.

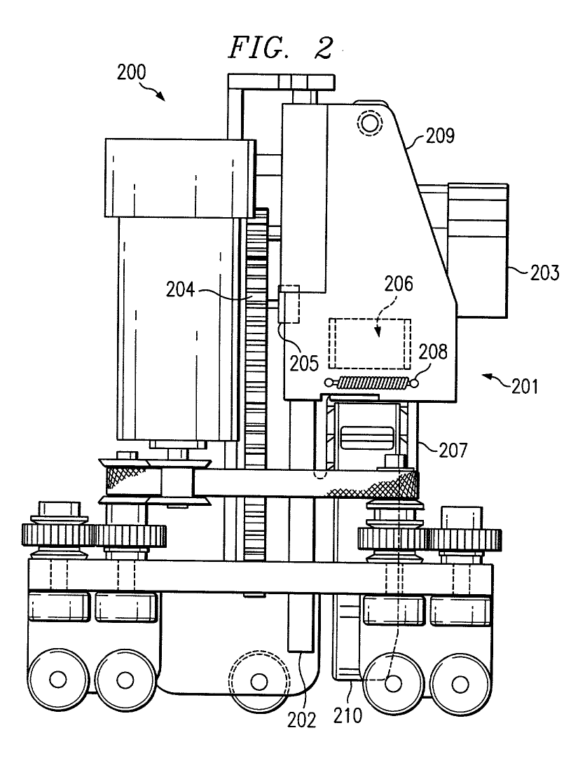

Referring now to FIG. 2, a pictorial diagram illustrating a robotic picker mechanism is depicted in accordance with the present invention. A picker sub assembly mounted to a robotic pod base assembly allows for the picking and placing of media cartridges in media cartridge storage cells, media cartridge players and auxiliary slots such as library loading windows. The robotic pod 200 has a picker assembly 201 mounted on linear guide rails 202 and is extensible by means of a reach drive motor 203 and integral reach drive gear/crank 204 operating with a cam follower 205 arranged to impart linear motion to the gripper assembly 201. The picker assembly 201 is mounted on a gripper carriage 209 that slides on rails 202. The picker assembly 201 is actuated by an electromechanical solenoid 206 to open gripper fingers 207 against a spring force from springs 208. An alternate method (not shown) for gripping the media cartridge would be to provide a cam driven mechanical latching device to eliminate the solenoid 206, thereby reducing mass and complexity of the picker subassembly 201.

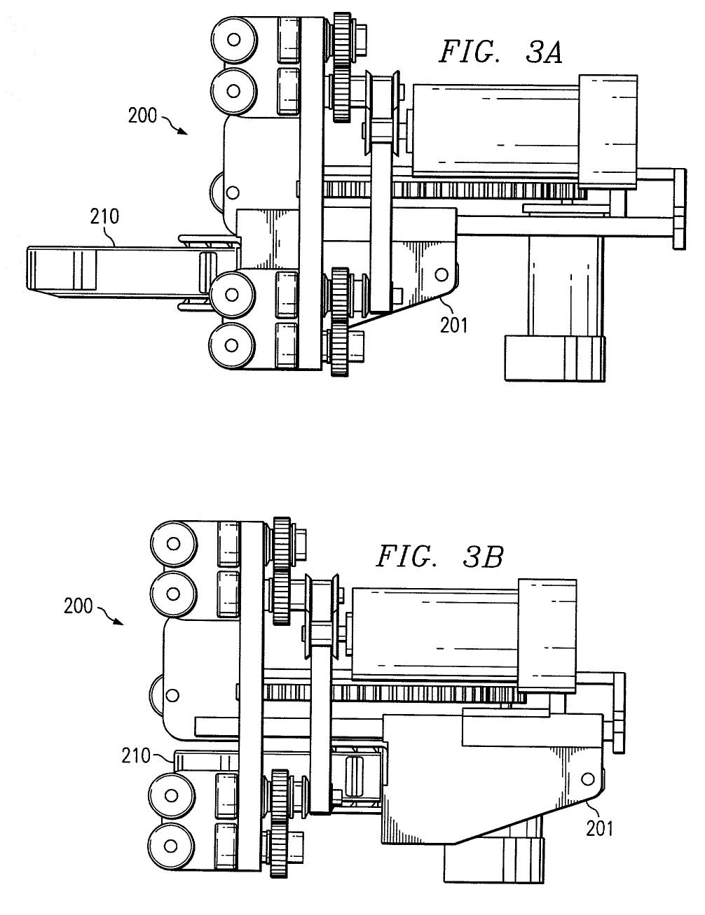

Referring to FIGS. 3A and 3B, pictorial diagrams illustrating the operation of a robotic picker mechanism are depicted in accordance with the present invention. The picker assembly 201 is made to constrain the media cartridge 210 in an onboard position or an extended position. FIGS. 3A and 3B illustrate side views of the robotic pod 200 in the extended and retracted positions, respectively. Thus, the picker mechanism 201 grasps the media cartridge 210 and, when retracted, pulls the media cartridge into the robotic pod 200 to enable transportation of the selected media cartridge 210 to a designated location by the movement of the robotic pod 200.

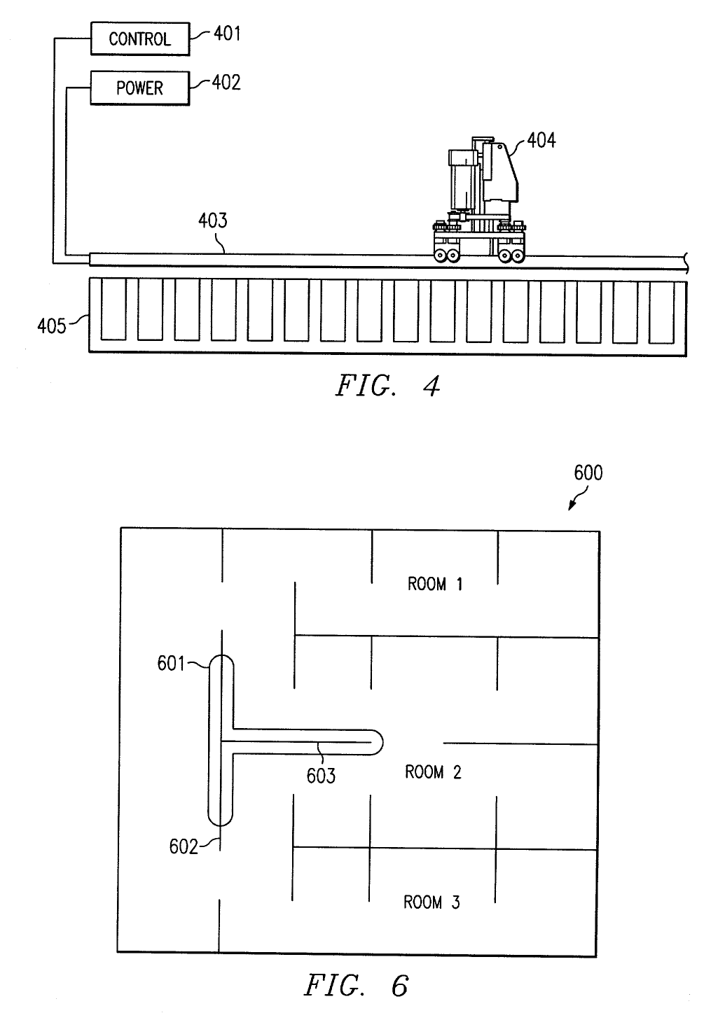

Referring to FIG. 4, a schematic diagram illustrating a stand-alone guide rail system is depicted in accordance with the present invention. The present invention builds upon the basic robot/guide rail design depicted in FIG. 1, but allows the guide rail system to provide power and control directly to the robots, independent of the enclosure housing the storage cell arrays.

By using the present invention, guide rail connectivity can incorporate any combination of straight and curved sections to arrive at a fully flexible architecture. The present invention also provides an extensible cabinet structure allowing containment of guide rails and associated media cells and accessories. This allows robots to share cabinet structures utilizing track connectivity to travel across cabinet boundaries, without additional electrical connectivity to the host module, and without additional electrical, optical or other wireless hardware. The guide rails provide integrated power and signal capability for robot power and control, which may be accomplished by means of multiple integrated conductors within the rails.

Referring back to FIG. 4, a power supply 402 provides power to robotic device 404 via power and ground conductors in rail 403. A controller 401, using processor and logic circuits, generates signals for use in controlling the movement and operations of robotic device 404. The controller 401 is also provided with modulator/demodulator circuitry to encode such communication signals and impress or superimpose such signals onto the power signal provided to the robotic device 404 via the power conductors in rail 403. Similar modulator/demodulator circuitry is provided onboard robot 404 to recover and decode the signals from controller 401. Once recovered and decoded, such signals are transmitted to motion controller circuitry onboard robot 404 in order to effect the desired movement and operation.

Robot 404 communicate with controller 401 in the same fashion, thereby providing feedback to the controller 401 concerning movement and operation of the robot 404, which information the controller 401 may use to generate further control signals. In that regard, such communication signals may be combined with the power signal in any fashion known in the art. For example, because power signals are typically lower frequency signals, communication signals may comprise higher frequency signals. Therefore, the power signal may be filtered out by robot 404 and controller 401 using high-pass filters to recover the communication signals. In such a fashion, high-speed full duplex communication may be implemented between the controller 401 and robot 404 without the need for multiple conductors, cabling, or wireless connection.

Prior art library systems require power and control to be handed off between enclosures as robots move from one enclosure to the next. By contrast, the present invention allows power and control over the robots to remain centralized within the integrated rail system itself. As can be seen in FIG. 4, the controller 401 and power source 402 are independent of the storage cell array 405 and feed directly into the rail system 403. The stand-alone nature of the rail system allows the rails to form customized pathways both within and between library enclosures, while maintaining a standard power and control system that is independent of the particular geometry of a given library system. This allows the guide rails to form complex pathways and geometric configurations, while maintaining uninterrupted power and control signals to the robots.

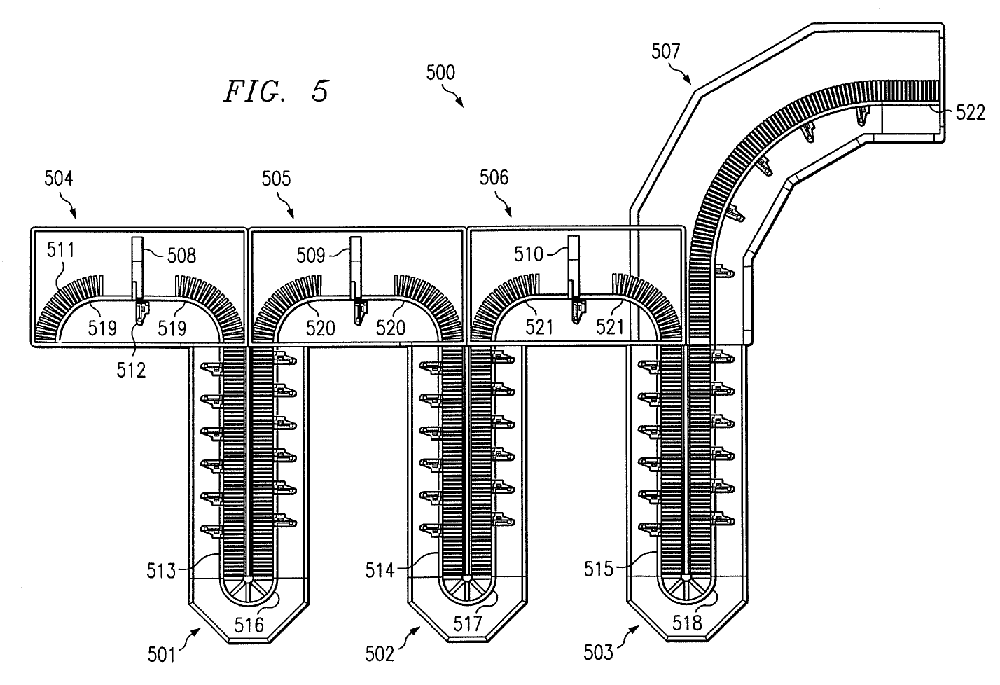

Referring to FIG. 5, a top view, pictorial diagram illustrating a library, with inside and outside curving connections, is depicted in accordance with the present invention. The library 500 is comprised of seven enclosures 501-507, each containing arrays of media storage cells, e.g. cell 511, and media retrieval robots, e.g., robot 512. In addition, enclosures 504-506 contain media players 508-510.

Enclosures 501-503 each have straight guide rails 513-515, respectively, and outside curving connector rails 516-518, respectively. Enclosures 504-506 contain inside curving guide rails 519-521, respectively, an either side of their respective media readers 508-510. Enclosure 507 contains a long curving guide rail 522.

While library 500 is comprised of three different enclosure configurations, the guide rails and robots within each respective enclosure form one integrated system, which is independent of those enclosures in terms of power supply and control functions. For example, using prior art methods, robot 512 would be considered a component of enclosure 504. If robot 512 were to move from enclosure 504 to enclosure 501, enclosure 504 would remove robot 512 from its inventory of available components, and enclosure 501 would add robot 512 to its own inventory of available components.

Unlike the prior art, the present invention does not require this handing off of power and control between enclosures 501 and 504. In the present invention, robot 512 is treated as a component of a single stand-alone guide rail system, and simply moves from one storage cell array to another. Robots are not added or removed from the system inventory unless the robots are physically added or removed from the guide rails.

The use of the present invention allows a single robot 512 to move along the twists and turns of the entire library 500 without any disruption in power and communication. This flexibility is not available with prior art systems, which rely on power and control methods such as cables, optical, infrared (IR), and radio frequency (RF). Cables would become tangled by such twists and turns through library 500. Optical, IR, and RF systems would be limited by the lack of a continuous line of sight and interference from enclosure walls. Such line-of-sight and interference problems are avoided with the present invention, and physical movement is unrestricted due to the absence of cables.

Referring to FIG. 6, a schematic diagram illustrating a stand-alone guide rail system without an enclosure is depicted in accordance with the present invention. FIG. 6 represents the most dramatic example of the present invention and takes the present invention to its logical conclusion. As described above, the present invention provides a guide rail system that is functionally independent of any enclosure or storage cell array in terms of power and control of robotic retrieval devices. Therefore, it is possible to implement a guide rail/robot system that is not contained within a conventional enclosure at all.

In FIG. 6, the guide rail 601 is mounted directly on two walls 602 and 603 within a building, without an enclosure surrounding the rail. Robots (not pictured) can use the guide rail 601 to retrieve items directly from the walls 602 and 603. For example, items (e.g., media cartridges) may be placed along walls 602 and 603. Robots operating on guide rail system 601 can then retrieve these objects. In a sense, the building 600 becomes the enclosure for the library system. FIG. 6 illustrates how the stand-alone guide rail system can be customized to fit almost any geometry needed by the designer.

While the example depicted in FIG. 5 above illustrates how the flexibility of the present invention can be applied using more conventional library enclosures, FIG. 6 illustrates how an integrated library system can be built around the rail system itself, rather than using preexisting enclosures and cell arrays as the starting elements.

In addition to the inside and outside curving paths depicted in FIG. 6, the present invention also allows the guide rail system to form other types of paths. Examples of these complex paths include sloping paths, upward, downward, diagonal, as well as non-orthogonal paths. Because power and control signals are supplied to the robots directly through the guide rails, the robots are able to receive uninterrupted power and guidance despite being out of the line of sight of the controller due to the complex paths formed by the guide rails.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A storage library, comprising:
at least one array of storage cells;
at least one guide rail running along the storage cells;
at least one robot coupled to the guide rail, wherein the robot moves along the guide rail and can manipulate objects within the storage cells;
at least one power source that supplies power to the robot; and
at least one controller that controls the movement of the robot;
wherein the robot receives uninterrupted power and control signals from the power source and controller directly through the guide rail, exclusive of other components in the library;
wherein the guide rail may form a complex path, including a path that takes the robot out of the line of sight of the controller, while maintaining uninterrupted power and control signals to the robot.

2. The storage library according to claim 1, further comprising an enclosure.

3. The storage library according to claim 1, further comprising a plurality of enclosures containing storage cell arrays, wherein a plurality of guide rails connect the plurality of enclosures, and wherein the robot receives uninterrupted power and control signals from the power source and controller directly through the guide rails, exclusive of other components in the library.

4. The storage library according to claim 1, wherein the storage cell array and guide rails are mounted on a wall.

5. The storage library according to claim 1, further comprising a plurality of robots.

6. The storage library according to claim 1, further comprising a plurality of guide rails.

7. A storage library, comprising:
a plurality of enclosures, wherein the enclosures contain storage cell arrays and robots coupled to guide rails, wherein the robots can manipulate objects within the storage cells, and wherein the guide rails run along the storage cell arrays and connect the enclosures;
at least one power source that supplies power to the robots; and
at least one controller that controls the movement of the robots;
wherein the robots receive uninterrupted power and control signals from the power source and controller directly through the guide rails, exclusive of other components in the library;
wherein the guide rails may form complex paths, including paths that take the robots out of the line of sight of the controller, while maintaining uninterrupted power and control signals to the robots.
